(19) United States
(12) Patent Application Publication
(10) Pub. No.: US 2024/0079684 A1
(43) Pub. Date: Mar. 7, 2024

(54) METHOD OF ASSEMBLING TRACTION BATTERY PACK AND TRACTION BATTERY PACK ASSEMBLY

(71) Applicant: Ford Global Technologies, LLC, Dearborn, MI (US)

(72) Inventors: Marc Dugas, Wixom, MI (US); Patrick Daniel Maguire, Ann Arbor, MI (US); Brock Dunlap, Dearborn, MI (US); Michael E. Reibling, Sterling Heights, MI (US)

(21) Appl. No.: 18/298,461

(22) Filed: Apr. 11, 2023

Related U.S. Application Data
(60) Provisional application No. 63/403,445, filed on Sep. 2, 2022.

(51) Int. Cl. H01M 10/658; H01M 50/211; H01M 50/595

(52) U.S. Cl. CPC H01M 10/658; H01M 50/211; H01M 50/595

(57) ABSTRACT

A method of assembling a battery pack includes, outside of a battery pack enclosure, securing at least one first battery cell to a first side of a thermal barrier, and securing at least one second battery cell to an opposite, second side of the thermal barrier. The method provides a battery cell subassembly with the thermal barrier sandwiched between the at least one first battery cell and the at least one second battery cell.

### CROSS-REFERENCE TO RELATED APPLICATIONS

This application claims priority to U.S. Provisional Application No. 63/403,445, which was filed on 2 Sep. 2022 and is incorporated herein by reference.

### TECHNICAL FIELD

This disclosure relates generally to assembling a traction battery pack and, more particularly, to using battery cell subassemblies within the traction battery pack.

### BACKGROUND

A traction battery pack of an electrified vehicle can include groups of battery cells arranged in one or more cell stacks. At least some of the battery cells can be electrically connected together.

### SUMMARY

In some aspects, the techniques described herein relate to a method of assembling a battery pack, including: outside of a battery pack enclosure, securing at least one first battery cell to a first side of a thermal barrier; and securing at least one second battery cell to an opposite, second side of the thermal barrier; and providing a battery cell subassembly with the thermal barrier sandwiched between the at least one first battery cell and the at least one second battery cell.

In some aspects, the techniques described herein relate to a method, wherein the at least one first battery cell and the at least one second battery cell are each pouch cells.

In some aspects, the techniques described herein relate to a method, further including securing the at least one first battery cell to the first side and securing the at least one second battery cell to the second side using an adhesive tape.

In some aspects, the techniques described herein relate to a method, wherein the thermal barrier is a metal or metal alloy.

In some aspects, the techniques described herein relate to a method, wherein the battery cell subassembly includes two first battery cells and two second battery cells.

In some aspects, the techniques described herein relate to a method, wherein the at least one first battery cell and the at least one second battery cell are battery cells of a traction battery pack.

In some aspects, the techniques described herein relate to a method, wherein, during the securing, the thermal barrier is vertically between the at least one first battery cell and the at least one second battery cell.

In some aspects, the techniques described herein relate to a method, wherein the battery cell subassembly is a first battery cell subassembly, and further including positioning the first battery cell subassembly alongside a second battery cell subassembly to establish at least a portion of a cell stack.

In some aspects, the techniques described herein relate to a method, wherein the first battery cell subassembly is positioned horizontally alongside the second battery cell subassembly.

In some aspects, the techniques described herein relate to a method, wherein the first battery cell subassembly is positioned alongside the second battery cell subassembly within a battery pack enclosure.

In some aspects, the techniques described herein relate to a method, wherein the thermal barrier extends vertically past an uppermost surface of the first battery cell and the second battery cell to contact an underside of the battery pack enclosure.

In some aspects, the techniques described herein relate to a method, wherein the thermal barrier is a first thermal barrier and further including positioning a second thermal barrier vertically above the at least one first battery cell and the underside of the battery pack enclosure.

In some aspects, the techniques described herein relate to a battery pack assembly, including: a thermal barrier; at least one first battery cell secured to a first side of the thermal barrier; and at least one second battery cell secured to an opposite, second side of the thermal barrier to provide a battery cell subassembly.

In some aspects, the techniques described herein relate to a battery pack assembly, wherein the battery cell subassembly is outside a battery pack enclosure.

In some aspects, the techniques described herein relate to a battery pack assembly, wherein the first and second battery cells are lithium-ion pouch cells.

In some aspects, the techniques described herein relate to a battery pack assembly, further including a first piece of adhesive tape securing the at least one first battery cell to the first side of the thermal barrier, and a second piece of adhesive tape secure the at least one second battery cell to the second side of the thermal barrier.

In some aspects, the techniques described herein relate to a battery pack assembly, wherein the first and second battery cells are constituents of a traction battery pack.

In some aspects, the techniques described herein relate to a battery pack assembly, wherein the at least one first battery cell includes a plurality of first battery cells adhesively secured together, wherein the at least one second battery cell includes a plurality of second battery cells adhesively secured together.

In some aspects, the techniques described herein relate to a battery pack assembly, wherein the first battery cell is adhesively secured to the first side, wherein the second battery cell is adhesively secured to the second side.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 1 according to an exemplary embodiment of the present disclosure.

FIG. 3 illustrates a perspective view of a battery cell from the battery pack of FIG. 2.

FIG. 4 illustrates a section view taken at line 4-4 in FIG. 3.

FIG. 5 illustrates a perspective view of a subassembly from the battery pack of FIG. 2 during assembly.

FIG. 6 illustrates a perspective view of the subassembly of FIG. 5 after assembly.

### DETAILED DESCRIPTION

This disclosure details exemplary methods of assembling a traction battery pack and, in particular, to creating subassemblies of battery cells for the traction battery pack. The disclosure additionally details exemplary battery packs that these subassemblies.

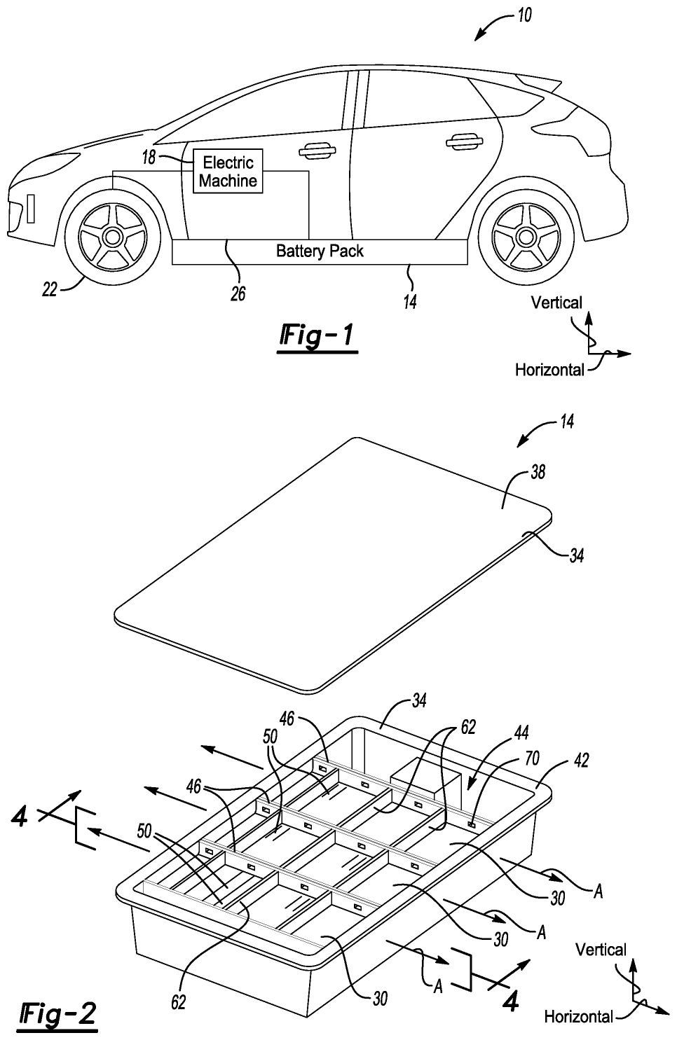

With reference to FIG. 1, an electrified vehicle 10 includes a battery pack 14, an electric machine 18, and wheels 22. The battery pack 14 powers an electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

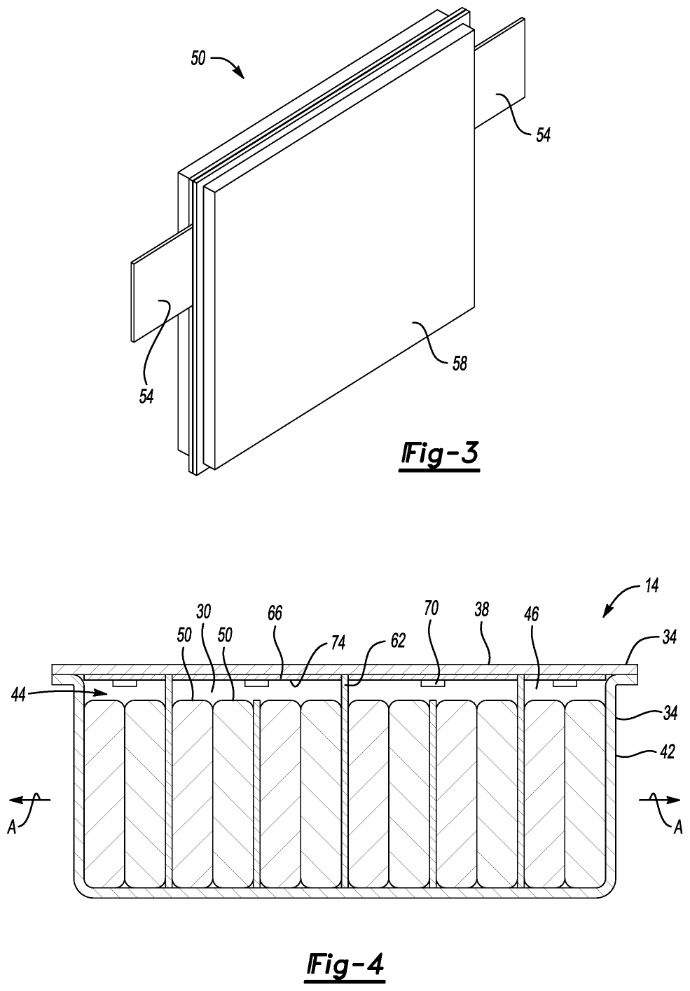

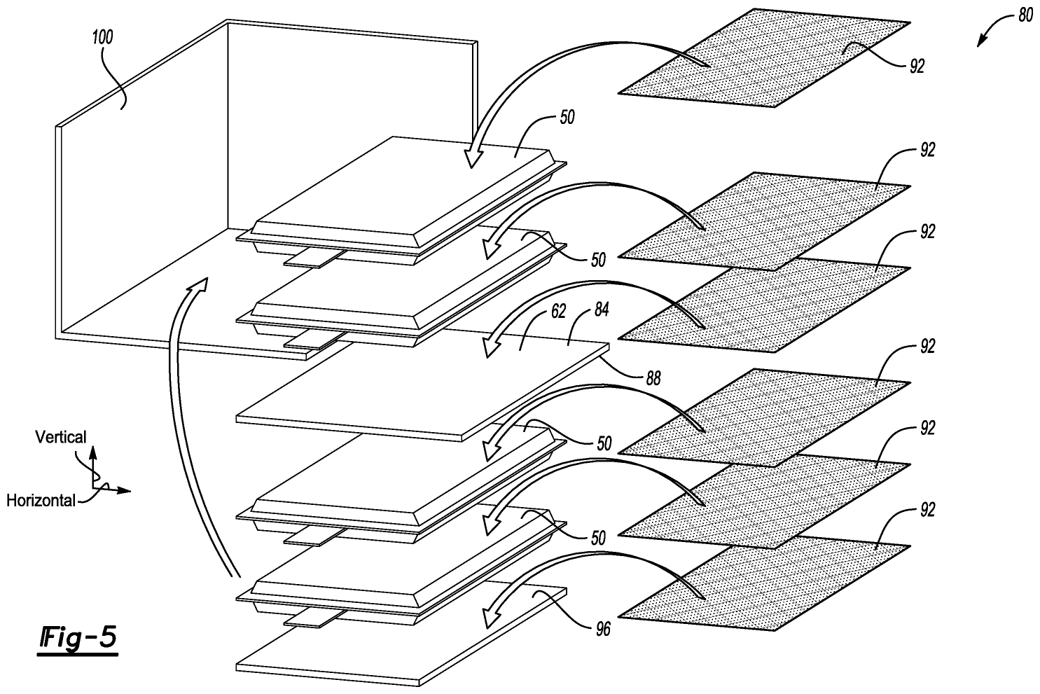

With reference now to FIGS. 2-4, the battery pack 14 includes a plurality of cell stacks 30 held within an enclosure assembly 34. In the exemplary embodiment, the enclosure assembly 34 includes an enclosure cover 38 and an enclosure tray 42. The enclosure cover 38 can be secured to the enclosure tray 42 to provide an interior area 44 that houses the cell stacks 30. The enclosure cover 38 can be secured to the enclosure tray 42 using mechanical fasteners (not shown), for example. Cross-members 46 are positioned between the cell stacks 30 within the interior area 44.

Each of the cell stacks 30 includes, among other things, a plurality of battery cells 50 (or simply “cells”) distributed along a respective cell stack axis A. In this example, the axes of the cell stacks 30 and the cross-members 46 are parallel to each other and extend longitudinally in a cross-vehicle direction. The axis A of the cell stacks 30 are horizontal when the battery pack 14 is installed within the vehicle 10. Horizontal and vertical, for purposes of this disclosure, are with reference to ground and a general orientation of the vehicle 10 during operation.

The battery cells 50 store and supply electrical power. Although a specific number of the cell stacks 30 and cells 50 are illustrated in the various figures of this disclosure, the battery pack 14 could include any number of the cell stacks 30 each having any number of individual cells 50.

In the exemplary embodiment, the battery cells 50 are lithium-ion pouch cells. However, battery cells having other geometries (cylindrical, prismatic, etc.), other chemistries (nickel metal hydride, lead acid, etc.), or both could be alternatively utilized within the scope of this disclosure. The exemplary battery cells 50 each include a pair of tab terminals 54 extending from opposing sides of a battery cell case 58. A multi-layered film can provide the case 58, for example. The tab terminals 54 can have opposite polarities (i.e., one positive and one negative). The tab terminals 54 can be a metal, such as copper or aluminum.

From time to time, pressure and thermal energy within one or more of the battery cells 50 can increase. The pressure and thermal energy increase can be due to an electrical short condition within the battery cell 50, for example. The pressure and thermal energy increase can cause the associated battery cell 50 to rupture and release vent byproducts, such as gas and debris, from within the battery cell 50.

Along the axis A of each cell stack 30, thermal barriers 62 are disposed between groups of cells 50. When the example battery pack 14 is assembled, the thermal barriers 62 extend vertically upward past uppermost surfaces of the battery cells 50. In the assembled battery pack 14, the thermal barriers 62 extend upward to contact an underside 66 of the enclosure cover 38. In another examples, the thermal barriers 62 only extend to the uppermost surfaces of the cells 50, or to some position between the uppermost surfaces of the cells 50 and the underside 66 of the enclosure cover 38.

The thermal barriers 62 are, in this example, stamped steel sheets sandwiched between layers of an aerogel material. The stamped steel can be about 0.7 millimeters thick, and the total thickness of the thermal barrier 62 can be about 4.5 millimeters.

Among other things, the thermal barriers 62 help to contain and redirect vent byproducts released from one or more of the battery cells 50. The thermal barriers 62 can block the vent byproducts, and constrain the thermal energy contained therein, from moving axially along the cell stack 30. If not blocked in this way, thermal energy associated with the vent byproducts could raise a temperature of other battery cells 50 causing those battery cells 50 to vent. The thermal barriers 62 compartmentalize the interior area 44, which helps to vent byproducts and inhibit thermal energy moving through the battery pack 14 and causing other battery cells 50 to vent.

In this example, the vent byproducts are directed outward from the axis of the cell stacks 30 through openings 70 in the cross-members 46 and into passageways within the cross-members 46. The vent byproducts can then be routed out interior area 44 of the enclosure assembly 34 through a vent (not shown) in the enclosure assembly 34, for example.

In the exemplary embodiment, the enclosure assembly 34, here the underside 66 of the enclosure cover 38, can be lined with a plurality of thermal barriers 74 to shield the enclosure cover 38 from a direct flow of vent byproducts venting upwards from one or more of the battery cells 50.

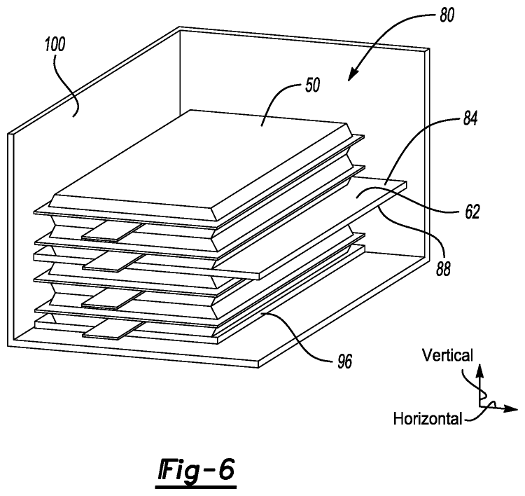

With reference now to FIGS. 5 and 6 and continued reference to FIGS. 2-4, the cell stacks 30 are provided by a plurality of battery cell subassemblies 80. In this example, the battery cell subassemblies 80 each include one of the thermal barriers 62, two battery cells 50 on a first side 84 of the thermal barrier 62, and two battery cells 50 on a second side 88 of the thermal barrier 62. The thermal barrier 62 is thus sandwiched between four battery cells 50 within the battery cell subassemblies 80.

The two battery cells 50 on the first side 84 are secured to each other and to the thermal barrier 62 with pieces of adhesive tape 92. Similarly, the two battery cells 50 on the second side 88 are secured to each other and to the thermal barrier with pieces of adhesive tape 92. While tape is used in this example. Other adhesives could be used in other examples. The cell subassemblies 80 additionally include, in this example, a cell pad 96.

Assembling the battery cell subassemblies 80 occurs outside of the enclosure assembly 34. Assembling can involve stacking the thermal barrier 62 vertically on top of two battery cells 50, and then stacking two more battery cells 50 vertically on top of the thermal barrier 62.

As the battery cells 50 are pouch cells, the battery cells 50 are substantially unsupported, which, among other things, can complicate repeatable positioning during assembly. Stacking the battery cells 50 and thermal barrier 62 vertically when assembling the subassemblies 80 can facilitate alignment until the battery cells 50 are secured.

A fixture 100 can be used to help align the battery cells 50 and the thermal barrier 62 when assembling the subassemblies 80. The fixture 100 can help to align the battery cells 50 and the thermal barrier 62 within the subassembly 80 particularly the surfaces that will be the vertical bottom of the subassembly 80 within the battery pack 14. Aligning the surfaces that will be the vertical bottom can help to reduce an amount of thermal interface material needed to fill gaps resulting from misalignments.

The thermal barrier 62 is a metal or metal alloy. Within the subassembly 80, the thermal barrier 62 helps to brace and support the battery cells 50. After the battery cells 50 and thermal barrier 62 are secured together, the battery cell subassembly 80 can be moved into the enclosure assembly 34. The thermal barrier 62 can help to hold a position of the battery cells 50 as the subassembly 80 is repositioned into the tray 42 of the enclosure assembly 34.

In this example, the battery cell subassemblies 80 are reoriented horizontally along the cell stack axis A when positioned within the enclosure assembly 34. A plurality of the battery cell subassemblies 80 can be positioned alongside each other to provide the cell stacks 30. In this example, three subassemblies 80 provide each cell stack 30. Positioning can be controlled, in some part, by locating off of the thermal barrier 62 for each of the subassemblies 80.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A method of assembling a battery pack, comprising:
outside of a battery pack enclosure, securing at least one first battery cell to a first side of a thermal barrier; and
securing at least one second battery cell to an opposite, second side of the thermal barrier; and
providing a battery cell subassembly with the thermal barrier sandwiched between the at least one first battery cell and the at least one second battery cell.

2. The method of claim 1, wherein the at least one first battery cell and the at least one second battery cell are each pouch cells.

3. The method of claim 1, further comprising securing the at least one first battery cell to the first side and securing the at least one second battery cell to the second side using an adhesive tape.

4. The method of claim 1, wherein the thermal barrier is a metal or metal alloy.

5. The method of claim 1, wherein the battery cell subassembly includes two first battery cells and two second battery cells.

6. The method of claim 1, wherein the at least one first battery cell and the at least one second battery cell are battery cells of a traction battery pack.

7. The method of claim 1, wherein, during the securing, the thermal barrier is vertically between the at least one first battery cell and the at least one second battery cell.

8. The method of claim 6, wherein the battery cell subassembly is a first battery cell subassembly, and further comprising positioning the first battery cell subassembly alongside a second battery cell subassembly to establish at least a portion of a cell stack.

9. The method of claim 7, wherein the first battery cell subassembly is positioned horizontally alongside the second battery cell subassembly.

10. The method of claim 7, wherein the first battery cell subassembly is positioned alongside the second battery cell subassembly within a battery pack enclosure.

11. The method of claim 9, wherein the thermal barrier extends vertically past an uppermost surface of the first battery cell and the second battery cell to contact an underside of the battery pack enclosure.

12. The method of claim 11, wherein the thermal barrier is a first thermal barrier and further comprising positioning a second thermal barrier vertically above the at least one first battery cell and the underside of the battery pack enclosure.

13. A battery pack assembly, comprising:
a thermal barrier;
at least one first battery cell secured to a first side of the thermal barrier; and
at least one second battery cell secured to an opposite, second side of the thermal barrier to provide a battery cell subassembly.

14. The battery pack assembly of claim 13, wherein the battery cell subassembly is outside a battery pack enclosure.

15. The battery pack assembly of claim 13, wherein the first and second battery cells are lithium-ion pouch cells.

16. The battery pack assembly of claim 13, further comprising a first piece of adhesive tape securing the at least one first battery cell to the first side of the thermal barrier, and a second piece of adhesive tape secure the at least one second battery cell to the second side of the thermal barrier.

17. The battery pack assembly of claim 13, wherein the first and second battery cells are constituents of a traction battery pack.

18. The battery pack assembly of claim 13, wherein the at least one first battery cell comprises a plurality of first battery cells adhesively secured together, wherein the at least one second battery cell comprises a plurality of second battery cells adhesively secured together.

19. The battery pack assembly of claim 13, wherein the first battery cell is adhesively secured to the first side, wherein the second battery cell is adhesively secured to the second side.
